(19) United States
(12) Patent Application Publication
(10) Pub. No.: US 2013/0080809 A1
(43) Pub. Date: Mar. 28, 2013

(54) SERVER SYSTEM AND POWER MANAGING METHOD THEREOF

(71) Applicant: Ying-Chih Lu, Taipei City (TW)

(72) Inventor: Ying-Chih Lu, Taipei City (TW)

(73) Assignee: INVENTEC CORPORATION, Taipei City (TW)

(21) Appl. No.: 13/426,197

(22) Filed: Mar. 21, 2012

(30) Foreign Application Priority Data
Sep. 28, 2011 (TW) 100135035

(51) Int. Cl. G06F 1/32; G06F 1/26

(52) U.S. Cl. 713/322; 713/300

(57) ABSTRACT

A server system and a power management method thereof are provided. The method includes following steps: detecting an utilization corresponding to at least one CPU in a specific node so as to calculate an average utilization of the specific node; judging a state of the specific node according to the average utilization; adjusting an operation parameter of the CPU to reduce the processing speed of the CPU when the state is lower than a normal-load state; adjusting the operation parameter of the CPU to advance the processing speed of the CPU so as to make the above-mentioned state back to the normal-load state when the state is higher than the normal-load state. The power management method dynamically adjusts the operation performance and duty-cycle of the CPU according to the utilization of the CPUs of the node so as to save power without affecting the working efficiency of the virtual machines.

### CROSS-REFERENCE TO RELATED APPLICATION

This application claims the priority benefit of Taiwan application serial no. 100135035, filed on Sep. 28, 2011. The entirety of the above-mentioned patent application is hereby incorporated by reference herein and made a part of this specification.

### BACKGROUND OF THE INVENTION

1. Field of the Invention

The invention generally relates to a power management mechanism, and more particularly, to a server system and a power management method thereof.

2. Description of Related Art

The cloud computing technology is one by using Internet linking massive servers so as to form and provide super-high computing and super-large storage capacity. The cloud computing technology is able to share and reorganize the software and hardware of the servers. In particular, the cloud system uses networks and browsers to operate the service web pages and uses the upper interface to conduct various computing and other work. Due to the massive number of the servers, the server group composed of the servers normally adopts a power management mechanism so as to reduce the power consumption.

FIG. 1 is a schematic diagram of a server system 100. In the server system 100, there are a lot of nodes PM. In fact, each of the nodes is a physical machine in the server system 100, and the nodes PM are connected to a network 110. Each of the nodes PM has at least one virtual machine VM, which coordinate with each other to perform cloud computing function through the network 110. A management server 120 performs power management on the nodes PM through the network 110. In some embodiments, the management server 120 can be one of the nodes in the server system 100, which is able to perform certain specific functions in the virtual machines VM so as to accomplish the power management mechanism.

In the prior art, the power management mechanism is designed to transfer some nodes PM with heavier load to the nodes PM with lighter load so as to balance the load of each node PM, and the above-mentioned action is termed as live migration of virtual machines VM so as to realize the load balance for each of the nodes.

After the live migration, if the average total load of each node PM is still low, all the virtual machines VM in some nodes PM can be transferred into other nodes PM and those nodes PM in vacancy, i.e., the nodes PM without virtual machines VM, are simply turned off, which can reduce the number of the nodes PM on operating and make the running nodes PM execute the functions of all the virtual machines VM with the most effective power efficiency. The above-mentioned action is termed as node power-off. On the contrary, if the average total load of each node PM is too high to be endured, some idle nodes PM would be turned on/restarted and the above-mentioned live migration of the virtual machines VM would be executed to maintain a better power efficiency, and such action is termed as node power-on.

In theory, although the above-mentioned power management mechanism can save more power, however, the virtual machines VM during the transferring would consume a lot of network bandwidth so that the integrated cloud computing performance is lowered down. The workload amount of each of the virtual machines VM may vary time to time with the user number and the types of software, so that it is hard to estimate the time point at which the workload change occurs. In this regard, if the nodes PM often perform live migration of the virtual machines VM and the power management mechanism of turning off and restarting, the cloud computing efficiency is definitely significantly reduced. In this regard, in the cloud computing technology, how to provide a better power management mechanism in a server system 100 with massive nodes has become an important and urgent development task nowadays.

### SUMMARY OF THE INVENTION

Accordingly, the invention is directed to a server system and a power management method thereof, which dynamically adjusts the operation performance and duty-cycle of a central processing unit (CPU) according to utilization of the CPU in a node so as to save power consumption without affecting the working efficiency of the virtual machines.

The invention provides a power management method of a server system. The above-mentioned server system includes a plurality of nodes. The power management method of a server system includes following steps: detecting an utilization corresponding to a CPU of each node (for example, a specific node) so as to calculate a CPU average utilization of the specific node; judging a state of the specific node according to the average utilization; adjusting an operation parameter of the CPU in the specific node to reduce the processing speed of the CPU so as to make the state back to the normal-load state and save power consumption when the state is lower than a normal-load state; and similarly, adjusting the operation parameter of the CPU in the specific node to advance the processing speed of the CPU so as to make the state back to the normal-load state when the state is higher than the normal-load state.

In an embodiment of the present invention, the above-mentioned power management method of a server system further includes a following step: performing a live migration procedure of virtual machine so as to balance the loads the nodes endure when the state is unable to make the state back to the normal-load state by adjusting the above-mentioned CPU operation parameter (for example, when the CPU state has been a full-load state and both the CPU operation performance and the CPU duty-cycle have been adjusted to the maximal values).

In an embodiment of the present invention, the above-mentioned power management method of a server system further includes following steps: performing a node power-off procedure in association with the above-mentioned live migration procedure of virtual machine so as to make the state of every node on operating back to the normal-load state when the above-mentioned state is unable back to the normal-load state by reducing the processing speed of the CPU. On the contrary, when the above-mentioned state is unable back to the normal-load state by advancing the processing speed of the CPU, the server system performs a node power-on procedure in association with the above-mentioned live migration procedure of virtual machine so as to make the state of every node on operating back to the normal-load state.

In an embodiment of the present invention, the step of judging the above-mentioned state of the specific node includes following steps: setting the above-mentioned state as a full-load state when the average utilization is higher than a highest CPU threshold; setting the above-mentioned state as a high-load state when the average utilization is higher than a high CPU threshold but lower than the highest CPU threshold; setting the above-mentioned state as the normal-load state when the average utilization is higher than a low CPU threshold but lower than the high CPU threshold; setting the above-mentioned state as the low-load state when the average utilization is lower than the above-mentioned low CPU threshold. In addition, when the average utilization is lower than an idle CPU threshold, the above-mentioned state is set as the idle-load state, in which the idle CPU threshold is lower than the low CPU threshold.

The invention also provides a server system, which includes a plurality of nodes and a management server, in which each of the nodes is considered as a physical machine, so that each of the nodes includes at least one CPU. Each of the nodes and the management server are coupled to a network. The management server detects a utilization corresponding to the CPU in each the node (for example, a specific node) so as to calculate an average utilization of the specific node and judge a state of the specific node according to the average utilization. When the above-mentioned state is lower than a normal-load state, the management server adjusts an operation parameter of the CPU in the specific node to reduce the processing speed of the CPU. When the above-mentioned state is higher than the normal-load state, the management server adjusts the operation parameter of the CPU in the specific node to advance the processing speed of the CPU so as to make the above-mentioned state back to the normal-load state. The other implementation details of the server system can refer to the above-mentioned description, which is omitted to describe.

Based on the depiction above, the conventional power management mechanism occupies more system resources and spends more processing time during working. On the contrary, the embodiment of the invention is able to dynamically adjust the running speed of the CPU according to the overall workload of each node (or the average utilization of CPUs of each node), which enables each node running in normal-load state so as to save power consumption without affecting the working efficiency of each node and without occupying the system resource.

In this way, the embodiment of the invention can avoid frequently executing the live migration procedure of virtual machine and the node power-off/on and reducing the efficiency of cloud computing. When the server system is still unable to run with a better electricity efficiency by adjusting the running frequency P and duty-cycle T of the CPU, the conventional power management mechanism is allowed to be executed to achieve a best power management performance.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram of a server system.

FIG. 2 is a flowchart of a power management method of a server system according to an embodiment of the invention.

FIG. 3 is a schematic diagram of a server system according to an embodiment of the invention.

FIG. 4 is a diagram showing BIOS, a chipset and one of physical CPU in a specific node.

FIG. 5 is a state table of average utilization of a CPU in a management server.

FIG. 6 is an operation parameter table of the CPU in the embodiment of the invention.

### DESCRIPTION OF THE EMBODIMENTS

It should be noted that the notations and partial content in the above-mentioned embodiment are continuously used, in which the same notations represent the same as or similar to the above-mentioned embodiment, while the same depictions are omitted and can be understood referring to the above-mentioned embodiment

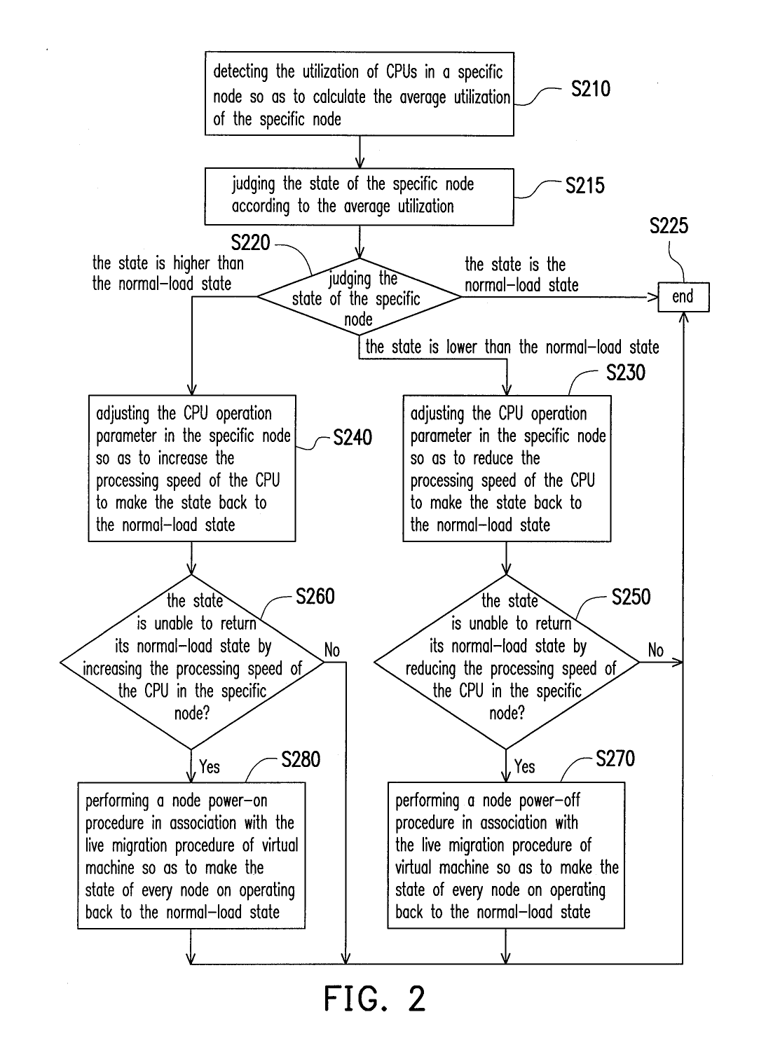

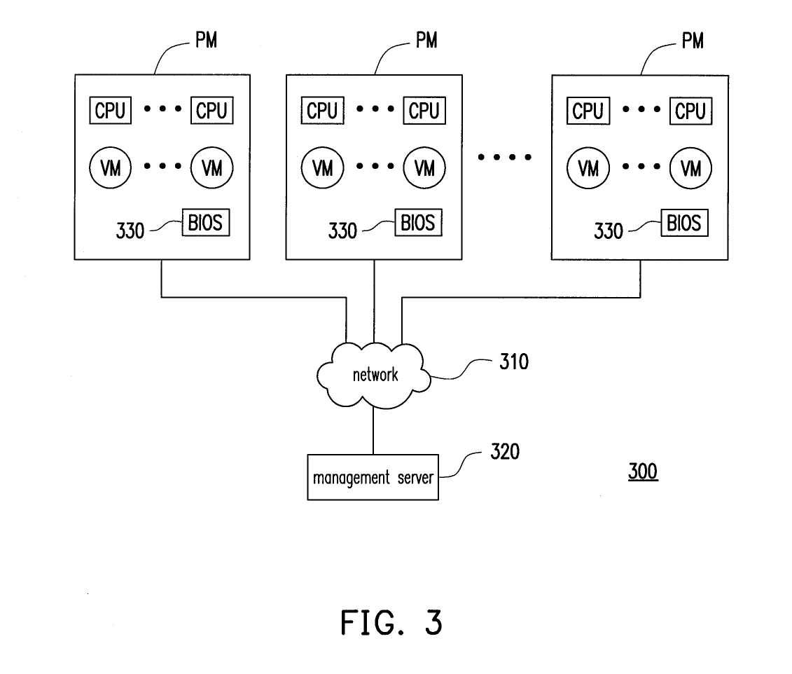

FIG. 2 is a flowchart of a power management method of a server system 300 according to an embodiment of the invention and FIG. 3 is a schematic diagram of a server system 300 according to an embodiment of the invention. In the embodiment, the server system 300 of FIG. 3 is used to execute the power management method of the server system 300 in FIG. 2.

Referring to FIGS. 2 and 3, the server system 300 has massive nodes PM, and each of the nodes PM can be a physical machine in the server system 300. The nodes PM and a management server 320 are connected to a network 310. Each of the nodes PM has at least one virtual machine VM, a plurality of CPUs and a BIOS 330 so as to execute cloud computing function through the network 310. The management server 320 executes power management on the nodes PM through the network 310. In some embodiments, the management server 320 can be a node PM in the server system 300 or refer to a power management mechanism of one of the virtual machines VM in a node PM.

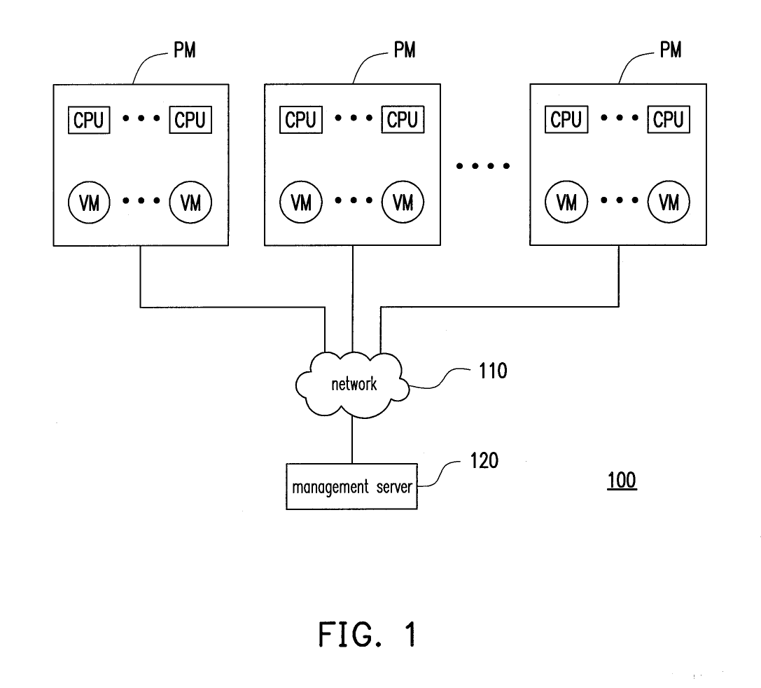

It should be noted that the physical machine PM herein can have a plurality of CPU slots so that many CPUs with multiple cores can be set up in a physical machine PM. For example, in the physical machine PM, a plurality of 4-cores CPUs can be set up, in which each core can further include at least one thread. In this regard, in the embodiment, a CPU with multiple cores is termed as a physical CPU, each core in each physical CPU is termed as a core CPU, and each core CPU includes a plurality of threads and each CPU thread is termed as a logic CPU. The CPU in the embodiment and FIGS. 1 and 3 can be a physical CPU, a core CPU or a logic CPU.

The power management method of the server system 300 is described as follows. In the embodiment, the power management procedure is executed in every certain time period (for example, in every 60 seconds). For simplicity, one of node PM is termed as a specific node. In step S210, the management server 320 detects the utilization of CPUs in a specific node and further calculates the average utilization of the specific node. The so-called utilization corresponding to the CPUs means the load level for the threads in each CPU to execute commands, and therefore, the utilization of each CPU can be obtained by averaging the load levels of all the threads in the CPU. A highest CPU utilization is 100% (at the time, all the threads are in full-load state), while a lowest CPU utilization is 0% (at the time, all the threads are almost in idle state).

Since each physical node PM includes a plurality of logic CPUs or a physical CPU, so that during calculating the average utilization of the CPUs in a specific node, it needs to detect out the utilization corresponding to each CPU in the specific node firstly. Then, the CPU utilizations are summed up and then divided by the number of the CPUs on the specific node for obtaining the average utilization of the CPUs in a specific node.

In particular, in the embodiment, all jobs for the management server 320 to detect the utilization corresponding to the CPUs of each node and to detect and control the CPU operation parameters can be done by utilizing the software system management interrupt (SW SMI) mechanism of BIOS in association with the chipset of each node PM, and such power management without using the baseboard management controller (BMC) is advantageous in lowering down the cost for setting up the nodes PM. In other embodiments, the management server 320 can also use the BMC in a node PM for detecting the CPU utilization, detecting the operation parameter and managing and controlling, which the invention is not limited to.

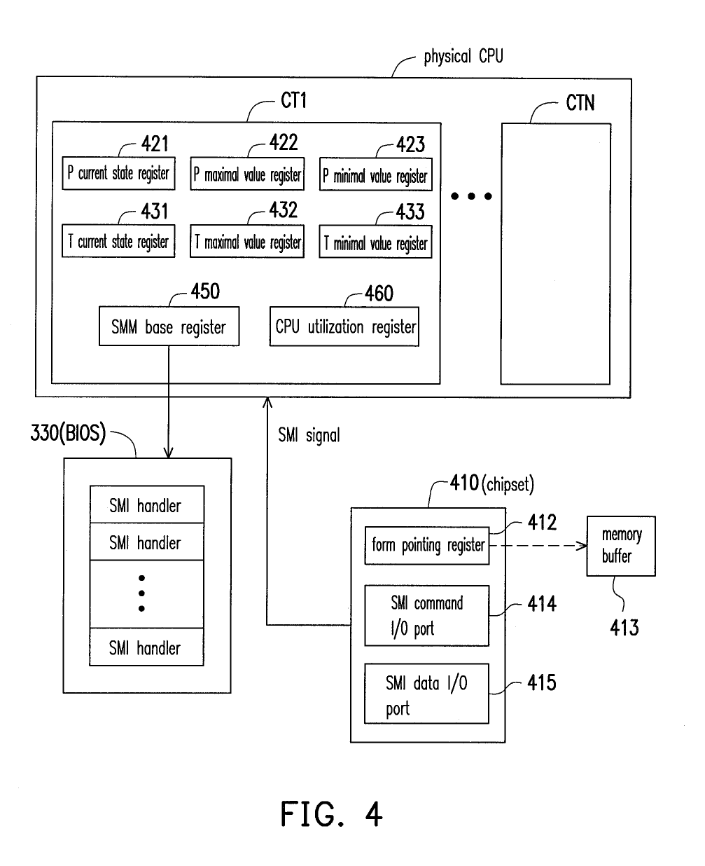

In following, the details of obtaining the utilization of each CPU in the node PM by using an SMI handler in the BIOS are described. FIG. 4 is a diagram showing BIOS 330, a chipset 410 and one of physical CPU in a specific node PM. For simplicity, the physical CPU in the embodiment is, for example, a core CPU with N threads, in which N is a positive integer. Each of the threads CT1-CTN contains a set of registers, in which CT1-CTN respectively represents the sets of registers located in the threads CT1-CTN. In the embodiment, each node PM can produce an SMI signal through the chipset 410 therein.

Taking an example, the chipset 410 includes a form pointing register 412, an SMI command I/O port 414 and an SMI data I/O port 415. The SMI command I/O port 414 and the SMI data I/O port 415 in the embodiment are implemented by registers and for executing the SMI command and data access of the SW SMI mechanism. A memory address is stored in the form pointing register 412 for pointing the repository of many forms in a memory buffer 413. In this way, an SMI handler (i.e., SMI program) of BIOS 330 can refer to a following form of CPU's current utilization state, a form of ranges of CPU's operation performance P and duty-cycle T and a form of operation parameters of CPU's operation performance P and duty-cycle T so as to provide the operation with required input and output parameters. In an example, it is assumed the address of the SMI command I/O port 414 is B2, the address of the SMI data I/O port 415 is B3, and F0 value is defined as the management command of the CPU thread of the SW SMI mechanism.

Continuing to FIG. 4, when the chipset 410 writes the F0 value into the address B2 of the SMI command I/O port 414, B2 would produce an SMI signal sent to the physical CPU. The physical CPU then jumps to the corresponding SMI handler in BIOS 330 for processing the SMI signal. In more details, the physical CPU would read the value in the address B2 of the SMI command I/O port 414 and obtain the F0 value. At the time, the physical CPU executes the management program of the CPU threads, and the program would further read the value in the address B3 of the SMI data I/O port 415 so as to know what assignment needs to be conducted. The value in the address B3 of the SMI data I/O port 415 is defined in the embodiment as follows:

0—the current utilization of the CPU obtained from the CPU register.

1—the operation performance P and the maximal value and minimal value of the duty-cycle T of the CPU obtained from the CPU register.

2—the values of the current operation performance P and duty-cycle T of the CPU obtained from the CPU register.

3—the setting values of the operation performance P and duty-cycle T on the CPU register.

The management program of the CPU threads would perform the above-mentioned tasks, but the input and output parameters required by the tasks can be obtained from the forms pointed by the form pointing register 412 in the memory buffer 413.

After the chipset 410 sends the SMI signal, all the threads in the CPU receive the SMI signal, and then, each of the threads would respectively read the corresponding SMI handler in the BIOS 330 so as to execute the handler and thereby obtain the corresponding CPU utilization and control the corresponding CPU according to the operation parameters.

For simplicity, in following, only a set of registers CT1 corresponding to a thread in a physical CPU is exemplarily described, and in FIG. 4, other sets of registers (for example, the architectures of the sets of registers CT2-CTN are omitted because the architectures of CT2-CTN are the same as CT1). In the embodiment, each of the sets of registers CT1-CTN includes: a system management mode (SMM) base register 450; a P current state register 421, a P maximal value register 422 and a P minimal value register 423 in which all 421, 422 and 423 are for controlling and registering the current state of operation performance P, the P maximal value and the P minimal value; a T current state register 431, a T maximal value register 432 and a T minimal value register 433 in which all 431, 432 and 433 are for controlling and registering the current state of duty-cycle T, the T maximal value and the T minimal value. The SMM base register 450 is for registering the starting point of the addresses in the BIOS 330 so as to store the entry of the SMI handler required to be executed in each of the threads. In addition, the sets of registers CT1-CTN further include a CPU utilization register 460 for registering the thread's utilization.

After each of the threads in the CPU receives the SMI signal, according to the above-mentioned architecture, the starting point of the addresses stored in the SMM base register 450 is used so that the workflow jumps to the entry of the SMI handler and the SMI handlers corresponding to all the threads start to be executed, followed by registering the relevant information obtained in each of the SMI handlers respectively in the corresponding one of the registers 421-460. In terms of the present workflow of the embodiment, a thread in the CPUs, called as system boot strap processor (SBSP), is used to execute the normal SMI handler, while other threads (called as application processors) take an action synchronous to the SBSP in semaphore way. Then, all the SMI handlers are ended by executing RSM command, and at the time all the CPUs leave from the system management mode (SMM). The SMI mechanism of CPUs are just a series of relevant actions of obtaining the utilization and operation parameter of each CPU and controlling the operation performance P and the duty-cycle T of each CPU by using the operation parameters.

On the other hand, the workflow of the above-mentioned SMI handler can be described as follows. First, the SMI handler analyses the SMI signal sent from the chipset 410 to judge the required actions to be executed. For example, the embodiment divides the SMI signal into four kinds:

command 0—obtaining the current utilization of the CPU.

command 1—obtaining the operation performance P, the maximal value and the minimal value of the duty-cycle T of the CPU.

command 2—obtaining the current operation performance P and duty-cycle T of the CPU.

command 3—setting the values of the current operation performance P and duty-cycle T.

After finishing the analysis of the SMI signal, the SMI handler executes corresponding actions through various forms pointed by the form pointing register 412 in the chipset 410 and according to the above-mentioned commands. For example, the output and input parameters of the command are obtained through the forms.

Referring to FIGS. 2 and 3 again, in step S215, the management server 320 judges the load state of the specific node according to the calculated CPU average utilization obtained in step S210. In the embodiment, the management server 320 can use a built-in CPU average utilization state table to judge the current load state of each node, in which the CPU average utilization state table can be adjusted and set by the user.

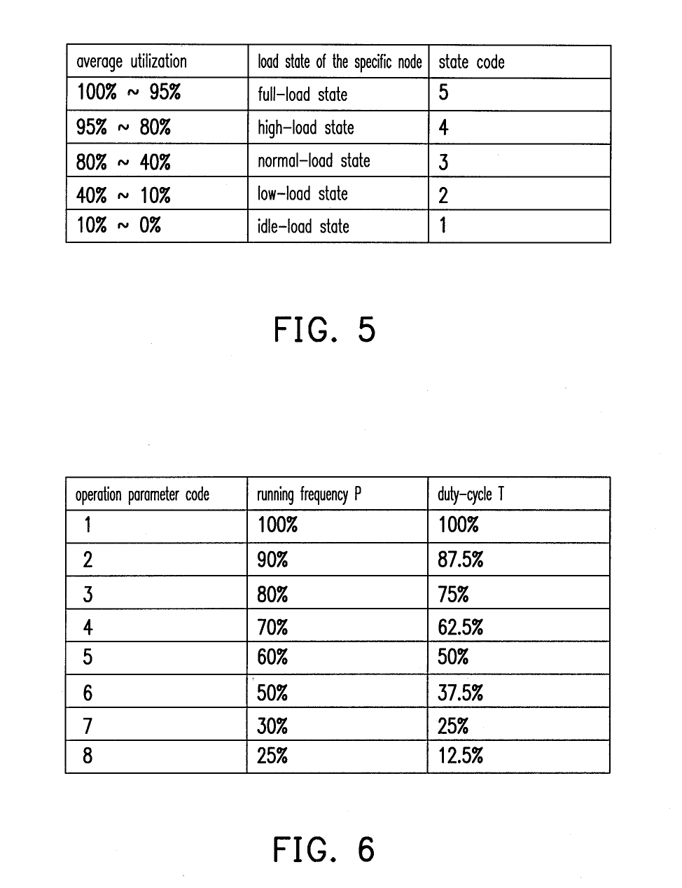

FIG. 5 is a state table of average utilization of a CPU in the management server 320. As shown by FIG. 5, since the highest CPU utilization is 100%, when the average utilization of the specific node is higher than the highest CPU threshold (for example, 95%) but less than or equal to 100%, the management server 320 sets the load state of the specific node as a full-load state. In other words, the state code of the specific node is set as 5. When the average utilization is higher than the high CPU threshold (for example, 80%) but less than the highest CPU threshold (for example, 95%), the management server 320 sets the load state of the specific node as a high-load state (the state code of the specific node is set as 4).

Analogically for the rest, when the average utilization is higher than the low CPU threshold (for example, 40%) but less than the high CPU threshold (for example, 80%), the state represents the specific node has a better power consumption and the virtual machines VM on the specific node can normally run without affecting the performance, and therefore, the state of the specific node is set as a normal-load state (accordingly, the state code of the specific node is set as 3). Further, when the average utilization is lower than the low CPU threshold (for example, 40%) or even less than the idle CPU threshold (for example, 10%), the load state of the specific node is set as a low-load state (the state code of the specific node is set as 2), or set as an idle-load state (the state code of the specific node is set as 1).

Referring to FIG. 2 again, the workflow enters step S220, and the management server 320 respectively judges the load state of each node PM. If the load state of every node PM is the normal-load state, the flow directly enters step S225 and the power management procedure is ended. When the load state of the specific node is lower than the normal-load state (state code is 3), for example, when the specific node is in the low-load state (state code is 2) or the idle-load state (state code is 1), the flow enters step S230 from step S220. At the time, the management server 320 adjusts the CPU operation parameters (for example, the CPU's operation performance P and duty-cycle T) to slow down the processing speed of the CPU and the state is expected back to the normal-load state so as to save the power consumption in the specific node.

On the contrary, when the load state of the specific node is higher than the normal-load state (state code is 3), for example, when the specific node is in the full-load state (state code is 5) or the high-load state (state code is 4), the flow enters step S240 from step S220. At the time, the management server 320 adjusts the CPU operation parameters (for example, the CPU's operation performance P and duty-cycle T) to speed up the processing speed of the CPU and the state is expected back to the normal-load state.

In order to slow down or speed up the processing speed of the CPU by adjusting the CPU operation parameters in the specific node, in the embodiment, the management server 320 uses the BIOS' SMI interface and a plurality of CPU operation parameter tables (respectively corresponding to each CPU) to respectively adjust the operation performance P and duty-cycle T of each CPU. FIG. 6 is an operation parameter table of the CPU in the embodiment of the invention.

In FIG. 6, the CPU operation parameter codes are used to set the operation performance P and duty-cycle T of each CPU, in which the operation performance P and duty-cycle T are expressed, for example, by percentages, as shown in FIG. 4. For example, when a CPU operation parameter code is set as 1, it means the CPU's operation performance P is set as the maximal value (100%) and the CPU's duty-cycle T is set as the maximal value (100%) as well. At the time, the CPU can process the commands with the maximal specified processing speed. On the contrary, when a CPU operation parameter code is set as 8, it means the CPU's operation performance P is set as 25% of the maximal value and the CPU's duty-cycle T is set as 12.5% of the maximal value. At the time, the CPU can process the commands with the minimum specified processing speed. It should be noted that anyone using the embodiment can adjust the data in the CPU operation parameter table of FIG. 6, which the invention is not limited to.

Step S240 is described by using FIG. 6 and an example. It is assumed that the load state of the specific node is the high-load state (the state code of the specific node is 4) and the operation parameter codes of all the CPUs in the specific node are set as 4, which means the operation performance P and duty-cycle T of each CPU are set respectively as 70% of the maximal value and 62.5% of the maximal value. Since the load state of the specific node (high-load state and state code of 4) is higher than the normal-load state (state code of 3), so that in step S240, the management server 320 obtains the previously set CPU operation parameter code (4) in the specific node firstly, and then, reduces the CPU operation parameter code value in the specific node (for example, the CPU operation parameter code is reduced to 3 from 4) so as to advance the processing speed of the CPU.

Step S230 is described by using FIG. 6 and an example. It is assumed that the load state of the specific node is the low-load state (the state code of the specific node is 2) and the operation parameter codes of all the CPUs in the specific node are set as 4. Since the load state of the specific node (low-load state and state code of 2) is lower than the normal-load state (state code of 3), so that in step S230, the management server 320 obtains the previously set CPU operation parameter code (4) in the specific node first, and then, increases the CPU operation parameter code value in the specific node (for example, the CPU operation parameter code is increased to 5 from 4) so as to reduce the processing speed of the CPU, and the load state of the specific node is expected back to the normal-load state.

According to the depiction above, the power management method of the embodiment is based on a time locality principle and can predict the incoming load states of every node according to the average utilization in every node obtained by detection and further adjust the CPU operation parameters. In this way, the average utilization of every node is expected to return to the normal-load state in the next workflow cycle.

Once the load state of the specific node has been the full-load state (state code of 5) and the operation performance codes of all the CPUs in the specific node have been set as 1 (i.e., every CPU is in full-load state), at the time, the above-mentioned power management method is unable to make every node back to the normal-load state by adjustment. Or once the load state of the specific node has been the idle-load state (state code of 1) and the operation performance codes of all the CPUs in the specific node have been set as 6 (i.e., every CPU is almost in idle-load state). At the time, the above-mentioned power management method is unable to make every node back to the normal-load state by adjustment. To solve the above-mentioned situations, the embodiment adopts an improved power management method combining the conventional power management mechanism.

Referring to FIG. 2, in step S250, when the load state of the specific node has been the idle-load state (state code of 1) and the processing speed of every CPU in the specific node has been reduced to its minimum value (i.e., the CPU operation parameter code has been set as 8), which means the load state of the specific node is unable to return its normal-load state by reducing the processing speed of the CPU in the specific node. At the time, the workflow enters step S270 where the management server 320 performs a live migration procedure of the virtual machine VM so as to balance the loads the nodes PM endure.

If the live migration procedure of the virtual machine VM is still unable to make the load state of the specific node back to the normal-load state, a node power-off procedure is performed which in association with the live migration procedure of the virtual machine VM, all the virtual machines VM of some nodes PM are transferred into other nodes and the nodes PM without the virtual machine VM therein are closed, which can reduce the number of the nodes PM on operating. If in step S250, the state can return to the normal-load state by reducing the processing speed of the CPU in the specific node, the power management procedure can be ended by going back to step S225 from step S250 or by finishing step S270 and then going back to step S225.

Continuing to FIG. 2, in step S260, when the load state of the specific node has been the full-load state (state code of 5) and the processing speed of every CPU in the specific node has been increased its maximal value (i.e., the CPU operation parameter code has been set as 1), the procedure enters step S280 where the management server 320 performs the live migration procedure of the virtual machine VM so as to balance the loads the nodes endure.

If the live migration procedure of the virtual machine VM is still unable to make the load state of the specific node back to the normal-load state, a node power-on procedure is performed so as to start or restart the nodes PM out of operating, in which the management server 320 in association with the live migration procedure of the virtual machine VM respectively transfers the virtual machines VM between the nodes PM according to the corresponding load levels thereof, so as to save power without affecting the operation performance of the virtual machine VM. Similarly to steps S250 and S270, in step S260, if the state can be back to the normal-load state by reducing the processing speed of the CPU in the specific node, the power management procedure can be ended by going back to step S225 from step S260 or by going back to step 225 after finishing step S280.

In summary, in comparison with the prior art where the conventional power management mechanism would occupy more system resource and spend more processing time during its workflow, the embodiment of the invention can dynamically adjust the processing speed of the CPU according to the overall load of each node (i.e., the utilization of the CPUs in each node), which enables each CPU running in the normal-load state to save power without affecting the operation performance of the virtual machine VM and occupying the system resource.

By using the power management method, the embodiment of the invention can avoid frequently executing the live migration of the virtual machines VM and the power management mechanism of turning off and restarting, and accordingly, the cloud computing efficiency is maintained. When the server system is unable to run in a better power efficiency by adjusting the running speed of each CPU, the embodiment adopts an improved power management method combining the conventional power management mechanism so as to achieve the best power management performance.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A power management method of a server system, wherein the server system comprises a plurality of nodes, and the power management method of a server system comprises following steps:
detecting at least one utilization corresponding to at least one central processing unit (CPU) in a specific node so as to calculate an average utilization of the specific node, wherein the specific node is one of the nodes;
judging a state of the specific node according to the average utilization;
adjusting an operation parameter of the CPU in the specific node to reduce the processing speed of the CPU so as to make the state back to the normal-load state when the state is lower than a normal-load state; and
adjusting the operation parameter to advance the processing speed of the CPU so as to make the state back to the normal-load state when the state is higher than the normal-load state.

2. The power management method of a server system as claimed in claim 1, further comprising a following step:
performing a live migration procedure of virtual machine so as to balance the loads of the nodes when the state is unable to make the state back to the normal-load state by adjusting the operation parameter.

3. The power management method of a server system as claimed in claim 2, further comprising a following step:
performing a node power-off procedure in association with the live migration procedure of virtual machine so as to make the state of every node on operating back to the normal-load state when the state is unable back to the normal-load state by reducing the processing speed of the CPU.

4. The power management method of a server system as claimed in claim 2, further comprising a following step:
performing a node power-on procedure in association with the live migration procedure of virtual machine so as to make the state of every node on operating back to the normal-load state when the state is unable back to the normal-load state by advancing the processing speed of the CPU.

5. The power management method of a server system as claimed in claim 1, wherein the step of judging the state of the specific node comprises following steps:
setting the state as a full-load state when the average utilization is higher than a highest CPU threshold;
setting the state as a high-load state when the average utilization is higher than a high CPU threshold but lower than the highest CPU threshold;
setting the state as the normal-load state when the average utilization is higher than a low CPU threshold but lower than the high CPU threshold;
setting the state as the low-load state when the average utilization is lower than the low CPU threshold,
wherein the full-load state and the high-load state are higher than the normal-load state and the low-load state is lower than the normal-load state.

6. The power management method of a server system as claimed in claim 5, wherein judging the state of the specific node further comprises a following step:
setting the state as the idle-load state when the average utilization is lower than an idle CPU threshold, wherein the idle CPU threshold is lower than the low CPU threshold and the idle-load state is lower than the normal-load state.

7. The power management method of a server system as claimed in claim 1, wherein the operation parameter of the CPU is an operation performance or a duty-cycle of the CPU.

8. A server system, comprising:
a plurality of nodes, wherein each of the nodes is coupled to a network and comprises at least one CPU;
a management server coupled to the network, wherein the management server detects an utilization corresponding to the CPU in a specific node so as to calculate an average utilization of the specific node, judges a state of the specific node according to the average utilization, adjusts an operation parameter of the CPU in the specific node to reduce the processing speed of the CPU when the state is lower than a normal-load state, adjusts the operation parameter to advance the processing speed of the CPU so as to make the state back to the normal-load state when the state is higher than the normal-load state, wherein the specific node is one of the nodes.

9. The server system as claimed in claim 8, wherein when the state is unable back to the normal-load state by reducing the processing speed of the CPU, the management server performs a live migration procedure of virtual machine and a node power-off procedure so that the state of every node on operating back to the normal-load state.

10. The server system as claimed in claim 8, wherein when the state is unable back to the normal-load state by advancing the processing speed of the CPU, the management server performs a node power-on procedure in association with a live migration procedure of virtual machine so that the state of every node on operating back to the normal-load state.
